(19) United States
(12) Patent Application Publication
(10) Pub. No.: US 2021/0042280 A1
(43) Pub. Date: Feb. 11, 2021

(54) HARDWARE ACCELERATION PIPELINE WITH FILTERING ENGINE FOR COLUMN-ORIENTED DATABASE MANAGEMENT SYSTEMS WITH ARBITRARY SCHEDULING FUNCTIONALITY

(71) Applicant: BigStream Solutions, Inc., Mountain View, CA (US)

(72) Inventors: Hardik Sharma, Mountain View, CA (US); Michael Brzozowski, Manhasset, NY (US); Balavinayagam Samynathan, Mountain View, CA (US)

(73) Assignee: BigStream Solutions, Inc., Mountain View, CA (US)

(21) Appl. No.: 16/988,650

(22) Filed: Aug. 8, 2020

Related U.S. Application Data
(60) Provisional application No. 62/885,150, filed on Aug. 9, 2019.

(51) Int. Cl. G06F 16/22; G06F 16/2457; G06F 16/2455; G06F 9/38; G06F 9/48; G06F 12/0882

(52) U.S. Cl. CPC G06F 16/221; G06F 16/24573; G06F 16/24552; G06F 12/0882; G06F 9/3887; G06F 9/3867; G06F 9/4881; G06F 16/24568

(57) ABSTRACT

Methods and systems are disclosed for a hardware acceleration pipeline with filtering engine for column-oriented database management systems with arbitrary scheduling functionality. In one example, a hardware accelerator for data stored in columnar storage format comprises memory to store data and a controller coupled to the memory. The controller to process at least a subset of a page of columnar format in an execution unit with any arbitrary scheduling across columns of the columnar storage format.

### RELATED APPLICATIONS

This application claims the benefit of U.S. Provisional Application No. 62/885,150, filed on Aug. 9, 2019, the entire contents of this Provisional application is hereby incorporated by reference.

### TECHNICAL FIELD

Embodiments described herein generally relate to the field of data processing, and more particularly relates to a hardware acceleration pipeline with filtering engine for column-oriented database management systems with arbitrary scheduling functionality.

### BACKGROUND

Conventionally, big data is a term for data sets that are so large or complex that traditional data processing applications are not sufficient. Challenges of large data sets include analysis, capture, data curation, search, sharing, storage, transfer, visualization, querying, updating, and information privacy.

Most systems run on a common Database Management System (DBMS) using a standard database programming language, such as Structured Query Language (SQL). Most modern DBMS implementations (Oracle, IBM, DB2, Microsoft SQL, Sybase, MySQL, Ingress, etc.) are implemented on relational databases. Typically, a DBMS has a client side where applications or users submit their queries and a server side that executes the queries. Unfortunately, general purpose CPUs are not efficient for database applications. On-chip cache of a general-purpose CPU is not effective since it's relatively too small for real database workloads.

### SUMMARY

For one embodiment of the present invention, methods and systems are disclosed for arbitrary scheduling and in-place filtering of relevant data for accelerating operations of a column-oriented database management system. In one example, a hardware accelerator for data stored in columnar storage format comprises memory to store data and a controller coupled to the memory. The controller to process at least a subset of a page of columnar format in an execution unit with any arbitrary scheduling across columns of the columnar storage format.

Other features and advantages of embodiments of the present invention will be apparent from the accompanying drawings and from the detailed description that follows below.

### BRIEF DESCRIPTION OF THE DRAWINGS

FIG. 1 shows an embodiment of a block diagram of a big data system 100 for providing big data applications for a plurality of devices in accordance with one embodiment.

FIG. 2 shows an example of a parquet columnar storage format.

FIG. 3 illustrates a pipelined programmable hardware accelerator architecture 300 that can accelerate the parsing of parquet columnar storage format 200 and can perform filtering based on repetition levels 241, definition levels 242, values 243, and other user-defined filtering conditions in accordance with one embodiment.

FIG. 4 shows a five-stage filtering engine as one embodiment of the filtering engine.

FIG. 5 illustrates a row group controller 500 having a dynamic scheduler in accordance with one embodiment.

FIG. 6 illustrates kernels in a pipeline of the accelerator in accordance with one embodiment.

FIGS. 7A-7I illustrate an example of round robin scheduling in accordance with one embodiment.

FIG. 8 illustrates an example of round robin scheduling for another embodiment.

FIG. 9 illustrates an example of optimized scheduling for another embodiment.

FIG. 10 shows functional blocks for sending data without batching.

FIG. 11 shows functional blocks for sending data with batching in accordance with one embodiment.

FIG. 12 shows functional blocks for batching in accordance with one embodiment.

FIG. 13 illustrates the schematic diagram of an accelerator according to an embodiment of the invention.

FIG. 14 illustrates the schematic diagram of a multi-layer accelerator according to an embodiment of the invention.

FIG. 15 is a diagram of a computer system including a data processing system according to an embodiment of the invention.

### DETAILED DESCRIPTION OF EMBODIMENTS

Methods, systems and apparatuses for accelerating big data operations with arbitrary scheduling and in-place filtering for a column-oriented database management system are described.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

HW: Hardware.

SW: Software.

I/O: Input/Output.

DMA: Direct Memory Access.

CPU: Central Processing Unit.

FPGA: Field Programmable Gate Arrays.

CGRA: Coarse-Grain Reconfigurable Accelerators.

GPGPU: General-Purpose Graphical Processing Units.

MLWC: Many Light-weight Cores.

ASIC: Application Specific Integrated Circuit.

PCIe: Peripheral Component Interconnect express.

CDFG: Control and Data-Flow Graph.

FIFO: First In, First Out [0033] NIC: Network Interface Card

HLS: High-Level Synthesis

KPN: Kahn Processing Networks (KPN) is a distributed model of computation (MoC) in which a group of deterministic sequential processes are communicating through unbounded FIFO channels. The process network exhibits deterministic behavior that does not depend on various computation or communication delays. A KPN can be mapped onto any accelerator (e.g., FPGA based platform) for embodiments described herein.

Dataflow analysis: An analysis performed by a compiler on the CDFG of the program to determine dependencies between a write operation on a variable and the consequent operations which might be dependent on the written operation.

Accelerator: a specialized HW/SW component that is customized to run an application or a class of applications efficiently.

In-line accelerator: An accelerator for I/O-intensive applications that can send and receive data without CPU involvement. If an in-line accelerator cannot finish the processing of an input data, it passes the data to the CPU for further processing.

Bailout: The process of transitioning the computation associated with an input from an in-line accelerator to a general-purpose instruction-based processor (i.e. general purpose core).

Continuation: A kind of bailout that causes the CPU to continue the execution of an input data on an accelerator right after the bailout point.

Rollback: A kind of bailout that causes the CPU to restart the execution of an input data on an accelerator from the beginning or some other known location with related recovery data like a checkpoint.

Gorilla++: A programming model and language with both dataflow and shared-memory constructs as well as a toolset that generates HW/SW from a Gorilla++ description.

GDF: Gorilla dataflow (the execution model of Gorilla++).

GDF node: A building block of a GDF design that receives an input, may apply a computation kernel on the input, and generates corresponding outputs. A GDF design consists of multiple GDF nodes. A GDF node may be realized as a hardware module or a software thread or a hybrid component. Multiple nodes may be realized on the same virtualized hardware module or on a same virtualized software thread.

Engine: A special kind of component such as GDF that contains computation.

Infrastructure component: Memory, synchronization, and communication components.

Computation kernel: The computation that is applied to all input data elements in an engine.

Data state: A set of memory elements that contains the current state of computation in a Gorilla program.

Control State: A pointer to the current state in a state machine, stage in a pipeline, or instruction in a program associated to an engine.

Dataflow token: Components input/output data elements.

Kernel operation: An atomic unit of computation in a kernel. There might not be a one to one mapping between kernel operations and the corresponding realizations as states in a state machine, stages in a pipeline, or instructions running on a general-purpose instruction-based processor.

Accelerators can be used for many big data systems that are built from a pipeline of subsystems including data collection and logging layers, a Messaging layer, a Data ingestion layer, a Data enrichment layer, a Data store layer, and an Intelligent extraction layer. Usually data collection and logging layer are done on many distributed nodes. Messaging layers are also distributed. However, ingestion, enrichment, storing, and intelligent extraction happen at the central or semi-central systems. In many cases, ingestions and enrichments need a significant amount of data processing. However, large quantities of data need to be transferred from event producers, distributed data collection and logging layers and messaging layers to the central systems for data processing.

Examples of data collection and logging layers are web servers that are recording website visits by a plurality of users. Other examples include sensors that record a measurement (e.g., temperature, pressure) or security devices that record special packet transfer events. Examples of a messaging layer include a simple copying of the logs, or using more sophisticated messaging systems (e.g., Kafka, Nifi). Examples of ingestion layers include extract, transform, load (ETL) tools that refer to a process in a database usage and particularly in data warehousing. These ETL tools extract data from data sources, transform the data for storing in a proper format or structure for the purposes of querying and analysis, and load the data into a final target (e.g., database, data store, data warehouse). An example of a data enrichment layer is adding geographical information or user data through databases or key value stores. A data store layer can be a simple file system or a database. An intelligent extraction layer usually uses machine learning algorithms to learn from past behavior to predict future behavior.

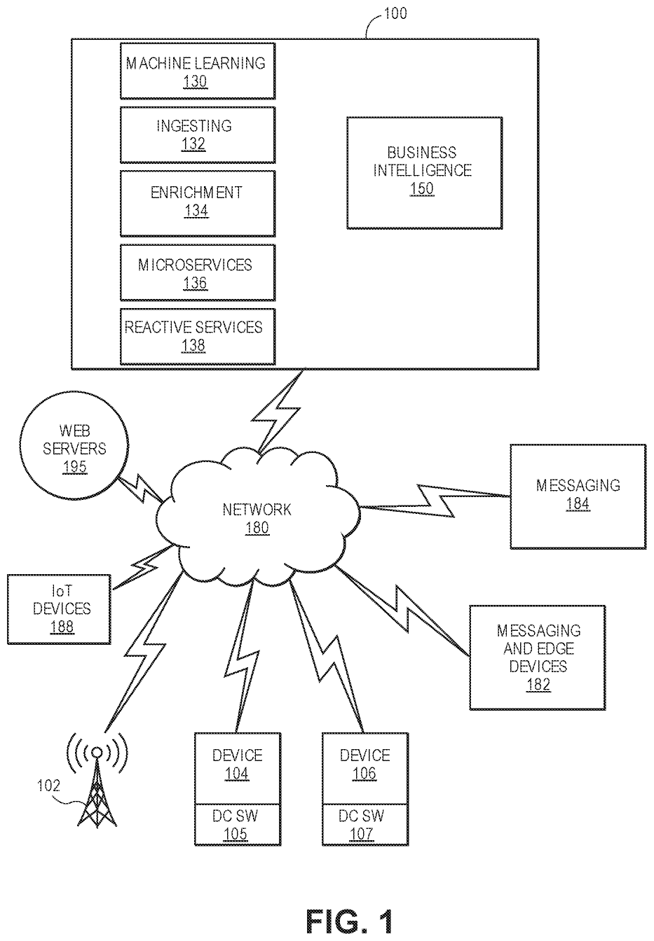

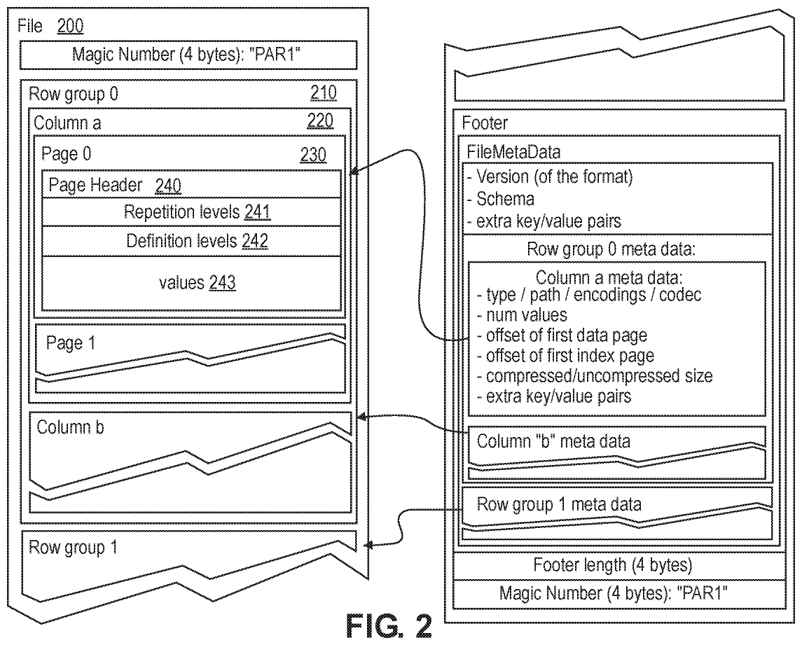

FIG. 1 shows an embodiment of a block diagram of a big data system 100 for providing big data applications for a plurality of devices in accordance with one embodiment. The big data system 100 includes machine learning modules 130, ingestion layer 132, enrichment layer 134, microservices 136 (e.g., microservice architecture), reactive services 138, and business intelligence layer 150. In one example, a microservice architecture is a method of developing software applications as a suite of independently deployable, small, modular services. Each service has a unique process and communicates through a lightweight mechanism. The system 100 provides big data services by collecting data from messaging systems 182 and edge devices, messaging systems 184, web servers 195, communication modules 102, internet of things (IoT) devices 186, and devices 104 and 106 (e.g., source device, client device, mobile phone, tablet device, laptop, computer, connected or hybrid television (TV), IPTV, Internet TV, Web TV, smart TV, satellite device, satellite TV, automobile, airplane, etc.). Each device may include a respective big data application 105, 107 (e.g., a data collecting software layer) for collecting any type of data that is associated with the device (e.g., user data, device type, network connection, display orientation, volume setting, language preference, location, web browsing data, transaction type, purchase data, etc.). The system 100, messaging systems and edge devices 182, messaging systems 184, web servers 195, communication modules 102, internet of things (IoT) devices 186, and devices 104 and 106 communicate via a network 180 (e.g., Internet, wide area network, cellular, WiFi, WiMax, satellite, etc.).

Columnar storage formats like Parquet or optimized row columnar (ORC) can achieve higher compression rates if dictionary decoding is preceded by Run Length Encoding (RLE) or Bit-packed (BP) encoding. Apache Parquet is an example of a columnar storage format available to any project in a Hadoop ecosystem. Parquet is built for compression and encoding schemes. Apache optimized row columnar (ORC) is another example of a columnar storage format.

As one embodiment of this present design, the parquet columnar storage format is explored. However, the same concepts apply directly to other columnar formats for storing database tables such as ORC. Data in parquet format is organized in a hierarchical fashion, where each parquet file 200 is composed of Row Groups 210. Each row group (e.g., row groups 0, 1) is composed of a plurality of Columns 220 (e.g., columns a, b). Each column is further composed of a plurality of Pages 230 (e.g., pages 0, 1) or regions. Each page 230 includes a page header 240, repetition levels 241, definition levels 242, and values 243. The repetition levels 241, definition levels 242, and values 243 are compressed using multiple compression and encoding algorithms. The values 243, repetition levels 241, and definition levels 242 for each parquet page 230 may be encoded using Run Length Encoding (RLE), Bit-packed Encoding (BP), a combination of RLE+BP, etc. The encoded parquet page may be further compressed using compression algorithms like Gzip, Snappy, zlib, LZ4, etc.

Operations with Parquet:

A typical operation on a database table using parquet columnar storage format 200 (e.g., file 200) is a decompression and decoding step to extract the values 243, definition levels 242, and repetition levels 241 from the encoded (using RLE+BP or any other encoding) and compressed (e.g., using GZIP, Snappy, etc) data. The extracted data is then filtered to extract relevant entries from individual parquet pages. Metadata-based filtering can be performed using definition levels 242 or repetition levels 241, and value-based filtering can be performed on the values 243 themselves.

The present design 300 (programmable hardware accelerator architecture) focuses on hardware acceleration for columnar storage format that can perform decompression, decoding, and filtering. A single instance of the design 300 is referred to as a single Kernel. The kernel 300 includes multiple processing engines (e.g., 310, 320, 330, 340, 350, 360, 370) that are specialized for computations necessary for processing and filtering of parquet columnar format 200 with various different compression algorithms (e.g., Gzip, Snappy, LZ4, etc) and encoding algorithms (e.g., RLE, RLE-BP, Delta encoding, etc).

In one embodiment of the present design for kernel 300, engines 310, 320, 330, 340, 350, 360, and 370 consume and produce data in a streaming fashion where data generated from one engine is directly fed to another engine. In another embodiment of the work, the data consumed and produced by engines 310, 320, 330, 340, 350, 360, and 370 is read from and written to either on-chip, off-chip memory, or a storage device.

The Configurable Parser engine 310 is responsible for reading the configuration or instructions that specify a parquet file size, compression algorithms used, filtering operation, and other metadata that is necessary for processing and filtering the parquet format file 200.

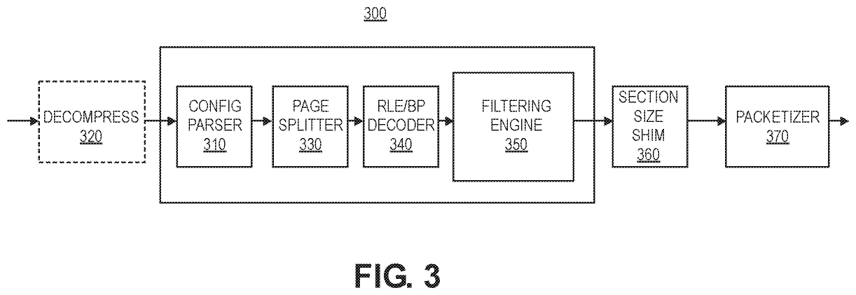

The Decompress engine 320 is responsible for decompression according to the compression algorithm used to compress the data (e.g., 241, 242, and 243). In some implementations, the Decompress engine 320 is preceded by the Configurable Parser engine 310 as shown in FIG. 3, to enable the compression of the configuration data (parquet file size, compression algorithms used, filtering operation, and other metadata). In other implementations, the Configurable Parser engine 310 precedes the Decompression engine 320.

The Page Splitter engine 330 is responsible for splitting the contents of the parquet file into page header 240, repetition levels 241, definition levels 242, values 243 so these can be individually processed by the proceeding engines.

The Decoding Engine 340 is responsible for further decompression or decoding of repetition levels 241, definition levels 242, and values 243. Based on the configuration accepted by the Config Parser engine 310, the decoding engine can perform decoding for RLE-BP, RLE, BP, Dictionary, Delta, and other algorithms supported for the parquet format 200 and other columnar formats like ORC.

The Filtering engine 350 (e.g., filtering single instruction multiple data (SIMD) engine 350, filtering very larger instruction word (VLIW) engine 350, or combination of both SIMD and VLIW execution filtering engine 350) is responsible for applying user-defined filtering conditions on the data 241, 242, 243.

Section size shim engine 360 is responsible for combining the filtered data generated by Filtering engine 350 into one contiguous stream of data.

Finally, in Packetizer engine 370, the data generated by the previous engines is divided into fixed sized packets that can be either written back to a storage device or off-chip memory.

The operations of Decompression Engine 320 and Decoding engine 340 result in a significant increase in the size of the data, which may limit performance when bandwidth is limited.

To overcome this limitation, the proposed hardware accelerator design of kernel 300 further includes a filtering engine 350 that performs filtering prior to the data being sent to a host computer (e.g., CPU) and significantly reduces the size of the data produced at the output of the pipeline. In one embodiment the filtering can be in-place, where the filtering operation is performed directly to the incoming stream of data coming from the Decoding Engine 340 into the Filtering engine 350. In another embodiment, the data from Decoding Engine 340 is first written to on-chip memory, off-chip memory, or to a storage device before being consumed by the Filtering engine 350.

Operators Supported by Filtering Engine:

The filtering engine 350 can apply one or more value-based filters and one or more metadata-based filters to individual parquet pages. The value-based filters keep or discard entries in a page based on the value 243 (e.g., value >5). The metadata-based filters are independent of values and either dependent on the def-levels 241, rep-levels 242, or the index of a value 243.

Overcoming Limited On-Chip Memory:

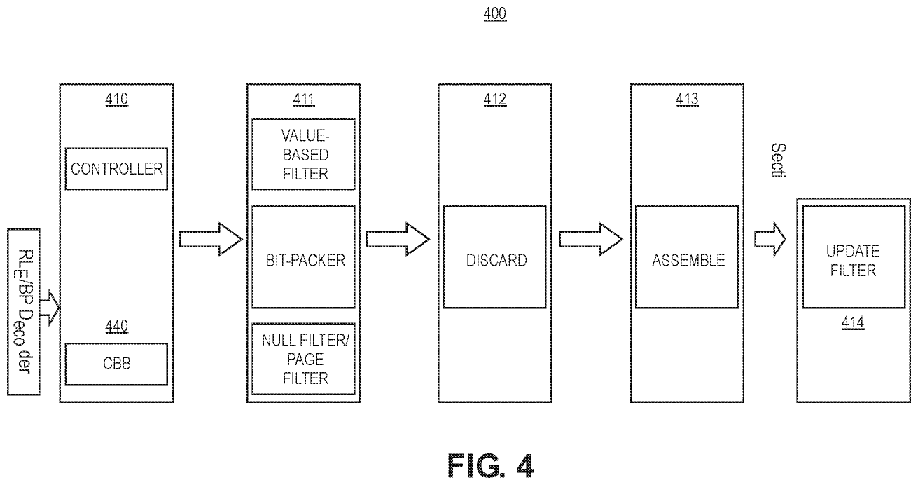

FIG. 4 shows a method of operating a filtering engine 400 as one embodiment of the hardware acceleration.

When an entry in a page of a column chunk is discarded by the filtering engine, the corresponding entry in a different column chunk can be discarded as well. However, since the filtering engine processes a single page at a time, it keeps track of which entries have been discarded in each page in a local memory 440 (e.g., Column Batch BRAM (CBB)), as shown in FIG. 4. The filtering engine 400 updates the memory 440 after processing each page and then applies this information to discard the corresponding entries in the next page.

Filtering Engine Architecture Overview:

The stage 410 (or operation 410) accepts data from the incoming stream from a RLE/BP decoder 404 (or any other decoding engine that precedes the filtering engine) and reads data from the memory 440. The memory 440 keeps track of the data filtered out by the previous column chunk.

The stage 411 (or operation 411) performs value-based and metadata-based filtering with a value-based filter and a null filter/page filter. In one example, this stage performs SIMD-style execution to apply value-based and metadata-based filtering to the incoming stream of data. Using SIMD-style execution, the same filter (example value >5) is applied to every value in the incoming value stream. Furthermore, multiple operations (such as value >5 and value <9) can be combined and executed as a single instruction, similar to VLIW (Very Large Instruction Word) execution. A stage 412 (or operation 412) discards data based on the filtering in the stage 411. A stage 413 (or operation 413) combines the filtered data and assembles the data to form the outgoing data stream 420.

A stage 414 (or operation 414) updates the memory 440 according to the filter applied for the current column chunk. This way the filtering engine gets more effective as the number of column chunks and the number of filters applied increase.

As discussed above, limited memory provides challenges for the hardware accelerator.

To be effective, the filtering engine 400 needs to keep track of which bits have been filtered out for a column chunk and discard the corresponding entries for other column chunks. As such, for large parquet pages, the amount of memory required to keep track of the filtered entries can exceed the limited on-chip or on-board memory for FPGA/ASIC acceleration. This present design overcomes this challenge by supporting partial filtering of pages to best utilize available memory capacity, called sub-page filtering. To this end, the filtering engine exposes the following parameters for effective scheduling:

1. Total number of entries in a page or region (e.g., parquet page)

2. Number of entries to be filtered in the page or region (e.g., parquet page). This specifies the number of entries in the parquet page to be filtered. The remaining entries are not filtered and passed through.

3. Range of entries valid in CBB 440: The range of entries that are valid in the CBB for the previous parquet column chunk. This allows the filtering engine to apply filters successively as the different pages are being processed.

4. Offset address for CBB 440

Target Hardware

The target pipeline can utilize various forms of decompression (e.g., Gzip, Snappy, zlib, LZ4, . . . ), along with the necessary type of decoder (e.g., RLE, BP, . . . ) and an engine to perform the filtering. In one embodiment, an internal filtering engine architecture utilizes a memory (e.g., CBB 440 and multiple SIMD (Single Instruction Multiple Data) lanes to store filtering results across columns, and produce filtered results as part of a larger pipeline to perform parquet page level filtering.

Execution Flow:

Normal

In a typical scheduler (e.g., Spark), each page of a column chunk is processed sequentially across columns. For example, if there are 3 columns in a row-group and each column chunk has 2 pages, then column 1 page 1 is processed and then column 2 page 1 is processed, after which column 3 page 1 is processed. Then the software scheduler moves on to processing page 2 of column 1, page 2 of column 2, and page 3 of column 3. Typically software implementations execute one page after the other in sequential fashion. These implementations are open-source.

Batched Schedule

The present design provides a hardware implementation that could support any algorithm to schedule processing of a set of column based pages by exposing the required parameters. Different schedules have varying impacts on the efficiency and parallelism of execution, and also impact the overhead and complexity of implementation. Simpler scheduling algorithms can be easier to support, at the potential cost of underutilization and inefficiency when one or more instances of the present hardware design of kernel 300 are used. A more elaborate scheduling algorithm can improve efficiency by maximizing the reuse of local memory information during filtering across multiple columns. It can also allow for the extraction of parallelism, by scheduling the processing of multiple pages, specifically pages in the same column, to be dispatched across multiple executors concurrently. These improvements can come at a heightened development and complexity cost. Local memory (e.g., a software-managed scratchpad and a hardware-managed cache) utilization and contention, and kernel utilization and number of kernels are among the parameters to consider for an internal cost function for determining efficiency of page scheduling algorithms.

Subpage Scheduling

The hardware of the present design allows for partial filtering during the processing of a page 210. When a page 210 is too large to fit filtering information in the local memory, or it is desirable to maintain the state of the local memory instead of overwriting, the hardware can still perform as much filtering as is requested before passing along the rest of the page to software. Software maintains information about how much filtering is expected in order to interpret the output results correctly.

Multiple Kernel/Execution Unit

The scheduling unit provides necessary infrastructure to process pages of the same row group across multiple execution units or kernels. As an example, if there are two column chunks 220 in a row group 210 and each column chunk has 2 pages 230 then the first pages of each column can be executed in one kernel and the second pages of each column can be executed in parallel on another column. This doubles the throughput of processing row-groups.

Dynamic Scheduling

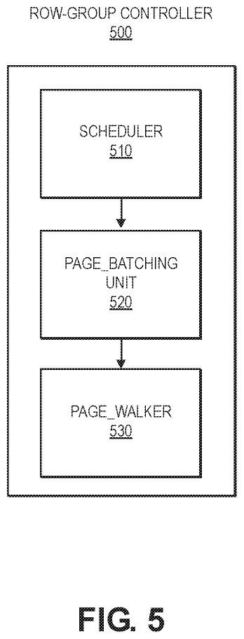

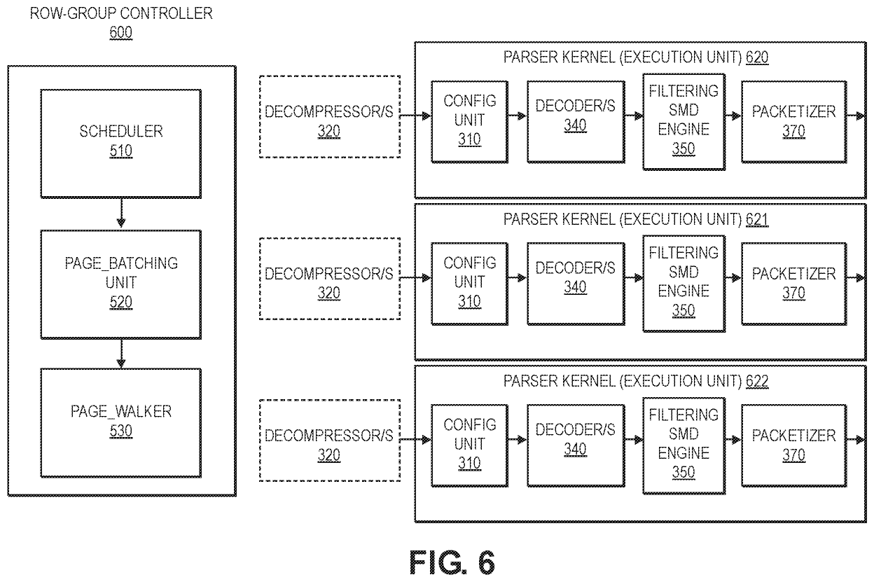

FIG. 5 illustrates a row group controller 500 having a dynamic scheduler in accordance with one embodiment. The scheduler 510 analyzes row groups 210 and based on a size and number of pages provides optimal ordering. The scheduler can be dynamic (e.g., scheduling determined at runtime) and has the ability to profile selectivity to influence an optimal ordering sequence. The scheduler 510 provides the ordered sequence to a page batching unit 520, which accepts this ordered sequence and dispatches the ordered sequence to the hardware accelerator design 300 as illustrated in FIG. 5. A page walker 530 accesses individual pages of a row group from memory and feeds it to a designated kernel in a pipeline of the accelerator as illustrated in FIG. 6. The page walker tracks pages processed across columns. Each parser kernel 620-622 (e.g., execution units 620-622) includes Config Parser 310, Decompression Engine 320, Page Splitter 330 (not shown in FIG. 6), Decoding Engine 340, Filtering Engine (e.g., filtering SIMD engine) 350, Section Size Shim 360 (not shown in FIG. 6) and a Packetized 370.

The scheduler can dynamically update the scheduling preferences in order to extract more parallelism and/or filter reuse. The scheduler has an internal profiler which monitors throughput to determine which pages could be advantageous to prioritize the scheduling to maximize the reuse of the filtering information stored in memory 440 and allow more data to discarded. The profiler is capable of utilizing feedback to improve upon its scheduling algorithm from additional sources such as Reinforcement Learning, or history buffers and pattern matching.

The present design provides increased throughput due to batched scheduling of pages and processing pages on multiple kernels (e.g., execution units) at the same time, the throughput can be substantially increased. The present design provides filter reuse with subpage scheduling. The partial filters in the memory 440 associated with a Filtering Engine 350 can be reused effectively across multiple columns. The present design also has a lower CPU utilization with filtering happening in a hardware accelerator, thus the workload on CPU reduces, leading to lower CPU utilization and better efficiency. Also, a reduced number of API calls occur due to the batched nature of scheduling. If the batch size is zero and there is a software scheduler, then for each individual page needs to be communicated to the accelerator using some API. With batching of multiple pages, API calls to an accelerator are reduced.

Round Robin

A round robin schedule is an example of a simple page scheduling algorithm. The algorithm iterates across the columns 220 and selects one page 210 from that column to schedule. This gives fair treatment to each column 220 but may result in inefficiency due to potential disparities in page sizes and the existence of pages with boundaries that do not align at the same row as boundaries of pages in other columns.

Round Robin (Largest Page First)

Largest page first round robin scheduling first has the option of choosing from the top unscheduled page of each column. It schedules these pages in order of decreasing size. Once all pages of this subset have been scheduled, a new subset is made from the next page in each column, and the subschedule is chosen again in order of decreasing size. This algorithm attempts to extract filter reuse by making the sequentially smaller pages reuse filter bits for all of their elements, not just partially. This algorithm is still prone to offset pages that cause thrashing in the scratchpad, resulting in no filter reuse.

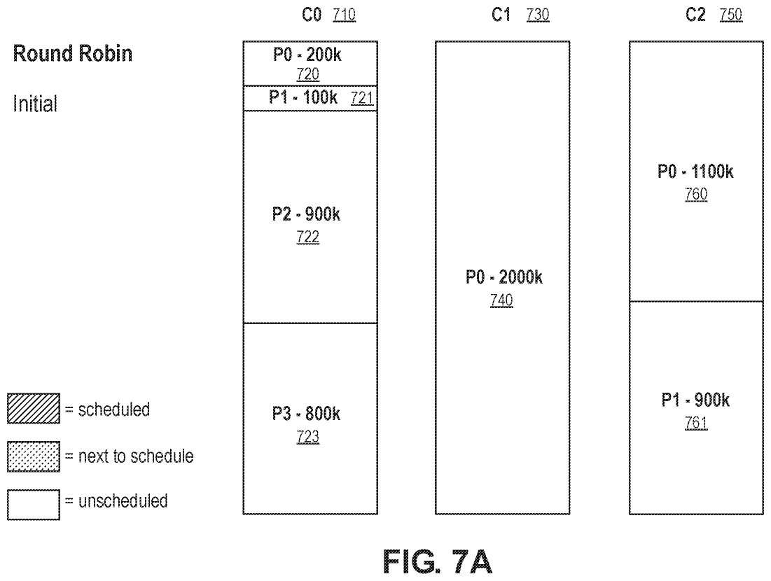

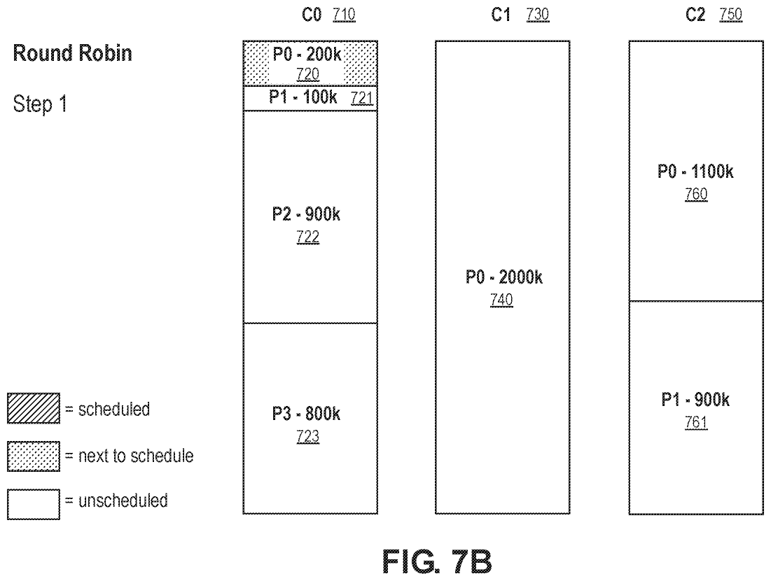

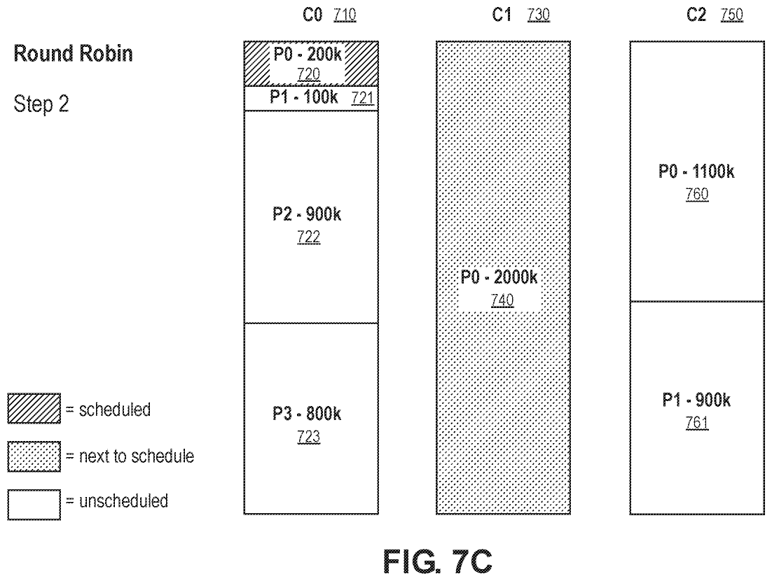

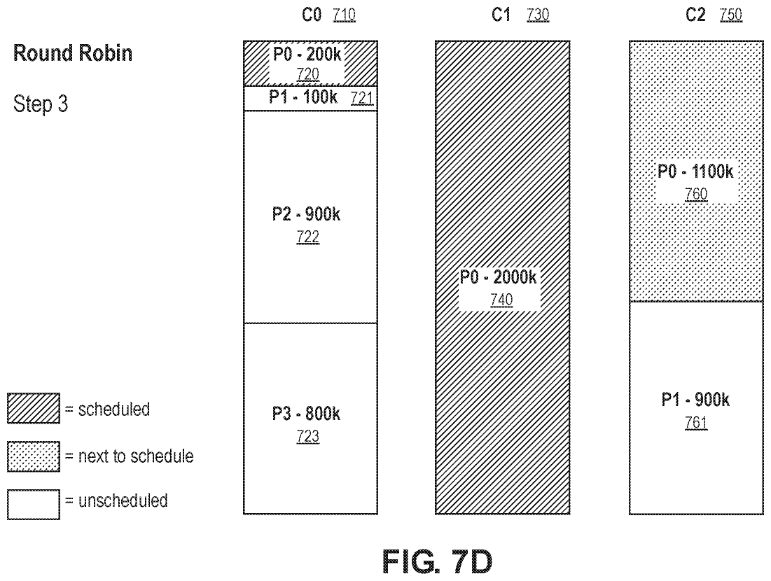

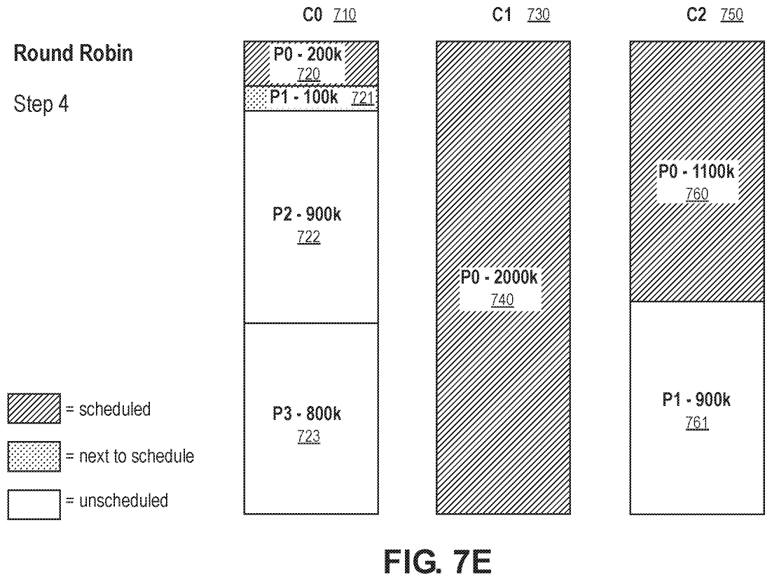

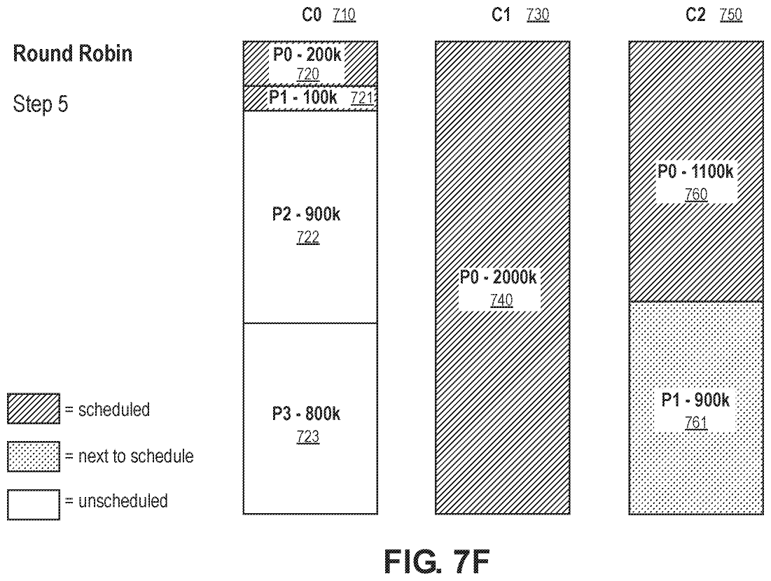

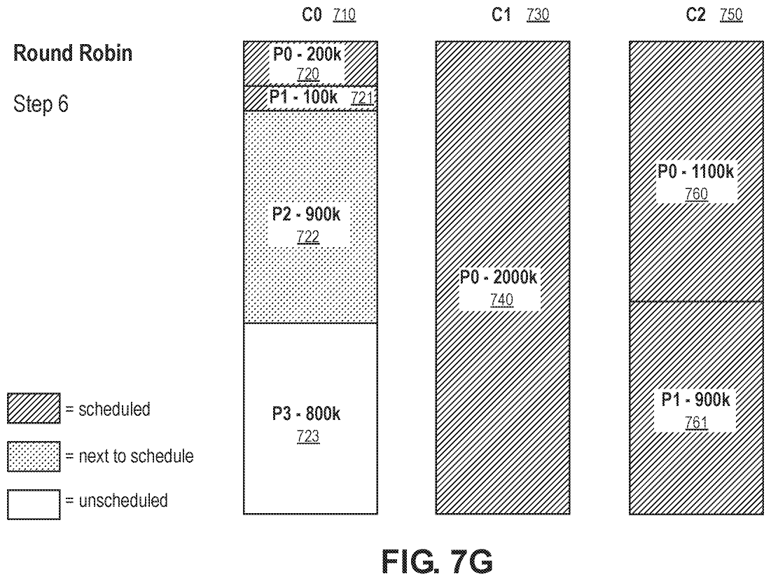

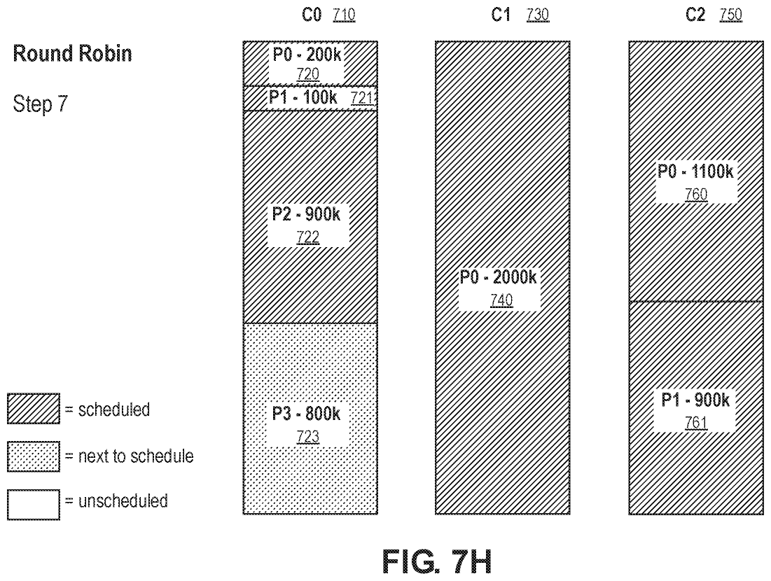

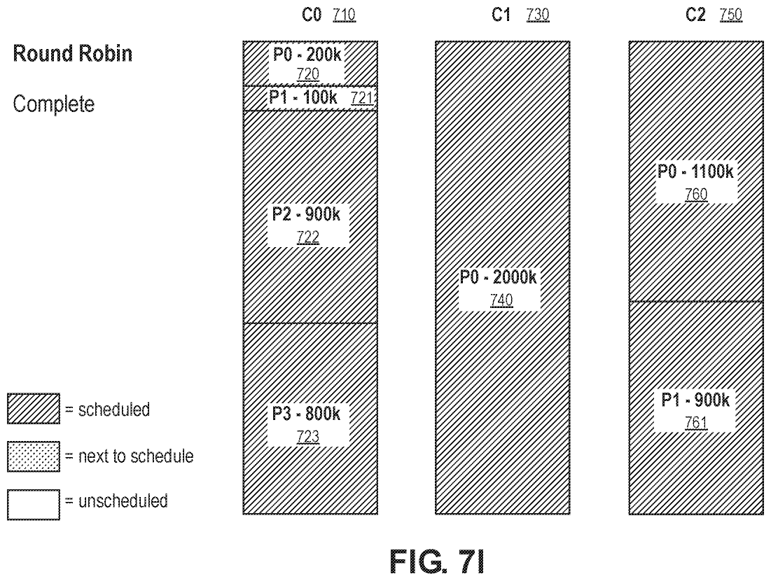

FIGS. 7A-7I illustrate an example of round robin scheduling in accordance with one embodiment. FIG. 7A illustrates an initial condition for column 0 710 (C0) having pages P0 720, P1 721, P2 722, and P3 723. Column 1 (C1 730) includes page P0 740 and column 2 750 (C2) includes pages P0 760 and P1 761. The pages can be various different sizes in accordance with different embodiments. In one example, P0 720 is 200 KB, P1 721 is 100 KB, P2 722 is 900 KB, P3 723 is 800 KB, P0 740 is 2000 KB, P0 760 is 1100 KB, and P1 761 is 900 KB.

FIG. 7B illustrates a first operation with page P0 720 of column C0 710 being next to schedule. FIG. 7C illustrates a second operation with page P0 720 of column C0 710 being scheduled and page P0 740 of column C1 730 being next to schedule. FIG. 7D illustrates a third operation with page P0 740 of column C1 730 being scheduled and page P0 760 of column C2 750 being next to schedule. FIG. 7E illustrates a fourth operation with page P0 760 of column C2 750 being scheduled and page P1 721 of column C0 710 being next to schedule. FIG. 7F illustrates a fifth operation with page P1 721 of column C0 710 being scheduled and page P1 761 of column C2 750 being next to schedule. FIG. 7G illustrates a sixth operation with page P1 761 of column C2 750 being scheduled and page P2 722 of C0 710 being next to schedule. FIG. 7H illustrates a seventh operation with page P2 722 of column C0 710 being scheduled and P3 723 of column C0 710 being next to schedule. FIG. 7I illustrates an eighth operation with page P3 723 of column C0 710 being scheduled and the round robin scheduling is now complete.

Column Exhaustive

A column exhaustive scheduling algorithm schedules all pages 230 in a column 220 before moving on to the next column 220. This is the simplest algorithm suited towards extracting parallelism across multiple kernels, as pages in the same column have no dependencies with one another.

Even Pacing Across Columns (Using Number of Rows)

This algorithm schedules a first page 230. A number of rows serves as a current max pointer to the memory 440. This algorithm schedules pages in such a fashion that a page comes as close to max pointer without exceeded it, until there are no small enough pages remaining. Max pointer is then pushed forward by the next page and the process repeats. This algorithm tries for maximum reuse of filter, but unlike round robin largest page first is not limited in choice at the cost of more complexity.

Even Pacing Across Columns (with Allowance of Buffer Size)

Same as previous, however once a page in a column has been scheduled, this algorithm will schedule as many pages from that column as possible without exceeding a buffer size amount of rows from the base pointer. Base pointer moves as the lowest row number across uncommitted pages. By preferring scheduling within a single column, parallelism across multiple kernels is maximized.

Even Pacing Across Columns (with Selectivity)

Same as previous, but choice is also weighed by selectivity, and prioritizes scheduling a set of pages with the highest selectivity first, in order to maximize filter reuse across columns.

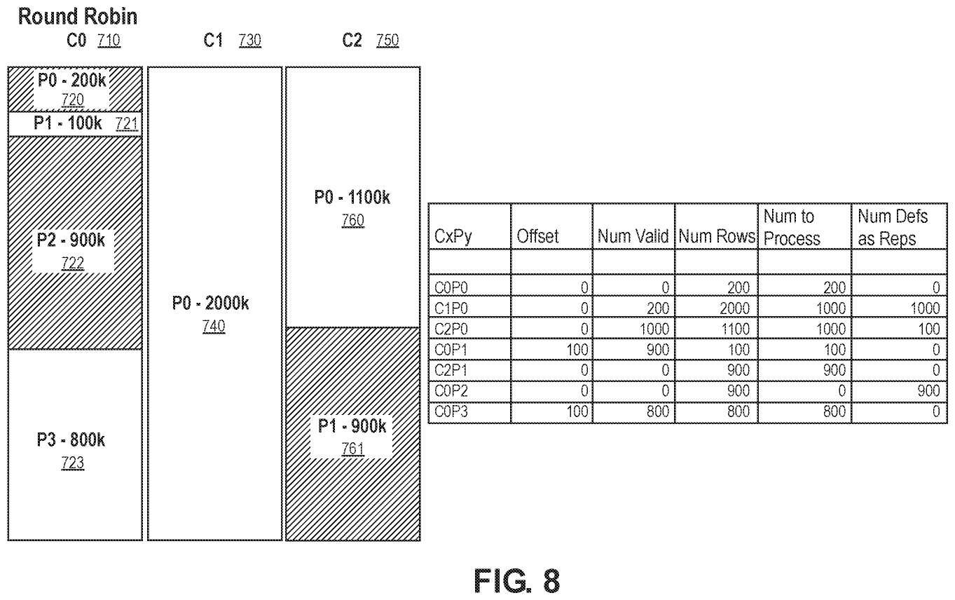

FIG. 8 illustrates an example of round robin scheduling in one embodiment when CBB size is sufficient to hold filtering information for only 100 KB entries but the number of entries in columns 710, 730, and 750 are 2000 KB entries. The pages are scheduled as indicated in the table with C0P0 720 being first, then C1P0 740, C2P0 760, C0P1 721, C2P1 761, C0P2 722, and C0P3 723. The columns in the table include different parameters (e.g., offset, number valid, number rows, number to process, number defs for repetitions) for determining a sequence or order of execution.

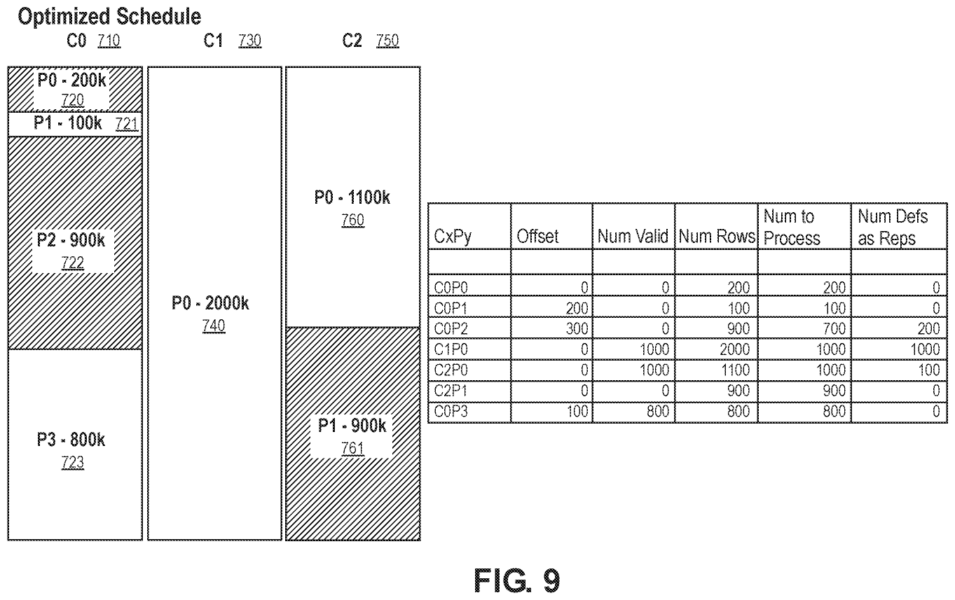

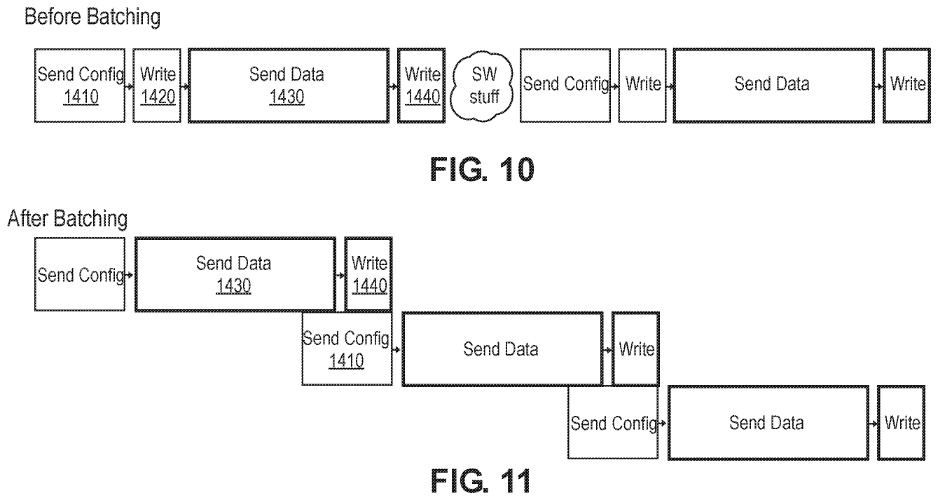

FIG. 9 illustrates an example of optimized scheduling for another embodiment. The pages are scheduled as indicated in the table with C0P0 720 being first, then C0P1 721, C0P2 722, C1P0 740, C2P0 760, C2P1 761, and C0P3 723. The optimized order is based on the parameters in the columns of this table of FIG. 10.

In order to minimize the number of interactions between the host CPU and the hardware accelerator kernel 300, this example dispatches multiple pages 230 of data from parquet columnar storage 200, ORC columnar format, row-based storage formats like JSON and CSV, and other operations in big data processing like sorting, shuffle, among others.

FIG. 10 shows the execution of individual pages 220 in parquet columnar format 200 blocks for sending and receiving data without batching in accordance with embodiment. Send Config 1410 refers to the consumption of configuration information or metadata that describes the parquet page 230 being read and the filtering operation that needs to be applied to the processed parquet page 230. Write 1420 writes back the results, if any, from consumption of the config in 1410. Send Data 1430 refers to both the sending of a parquet page 230 to the hardware accelerator kernel 300 and the processing of the parquet page 230 by the kernel 300. Write 1440 refers to the write back of processed and filtered results,

Without batching, the execution of steps 1410-1440 is serialized and interaction between software and the hardware kernel 300 can cause reduction in performance.

FIG. 11 shows functional blocks for sending data with batching in accordance with one embodiment. With batching, the interaction between software and hardware kernel 300 is minimized. With just one hardware-software interaction, multiple pages can be scheduled. Further, operations 1410, 1420, 1430, and 1440 can be overlapped to further improve performance. The order in which the pages are executed is determined by the schedule that is either determined dynamically by the hardware or generated by the software using the schemes mentioned in FIGS. 7A-7I, 8, and 9.

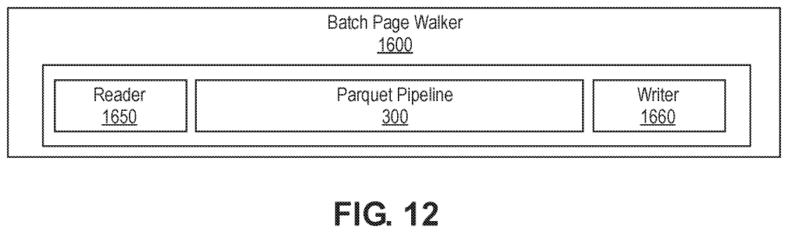

FIG. 12 shows functional blocks for batching in accordance with one embodiment. A batch page walker 1600 includes a reader 1650, a parquet accelerator kernel 300, and a writer 1660. The reader 1650 is responsible for reading the configuration, input parquet page 230, and other data necessary to process and filter the parquet page. The writer 1660 is responsible for writing back the processed and filtered results from individual pages.

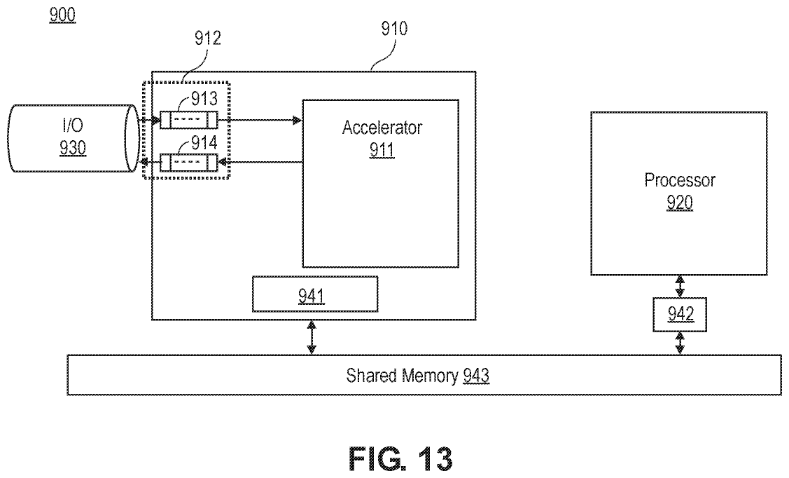

FIG. 13 illustrates the schematic diagram of data processing system 900 according to an embodiment of the present invention. Data processing system 900 includes I/O processing unit 910 and general-purpose instruction-based processor 920. In an embodiment, general purpose instruction-based processor 920 may include a general-purpose core or multiple general purpose cores. A general purpose core is not tied to or integrated with any particular algorithm. In an alternative embodiment, general purpose instruction-based processor 920 may be a specialized core. I/O processing unit 910 may include an accelerator 911 (e.g., in-line accelerator, offload accelerator for offloading processing from another computing resource, or both) for implementing embodiments as described herein. In-line accelerators are a special class of accelerators that may be used for I/O intensive applications. Accelerator 911 and general-purpose instruction-based processor may or may not be on a same chip. Accelerator 911 is coupled to I/O interface 912. Considering the type of input interface or input data, in one embodiment, the accelerator 911 may receive any type of network packets from a network 930 and an input network interface card (NIC). In another embodiment, the accelerator maybe receiving raw images or videos from the input cameras. In an embodiment, accelerator 911 may also receive voice data from an input voice sensor device.

In an embodiment, accelerator 911 is coupled to multiple I/O interfaces (not shown in the figure). In an embodiment, input data elements are received by I/O interface 912 and the corresponding output data elements generated as the result of the system computation are sent out by I/O interface 912. In an embodiment, I/O data elements are directly passed to/from accelerator 911. In processing the input data elements, in an embodiment, accelerator 911 may be required to transfer the control to general purpose instruction-based processor 920. In an alternative embodiment, accelerator 911 completes execution without transferring the control to general purpose instruction-based processor 920. In an embodiment, accelerator 911 has a master role and general-purpose instruction-based processor 920 has a slave role.

In an embodiment, accelerator 911 partially performs the computation associated with the input data elements and transfers the control to other accelerators or the main general-purpose instruction-based processor in the system to complete the processing. The term “computation” as used herein may refer to any computer task processing including, but not limited to, any of arithmetic/logic operations, memory operations, I/O operations, and offloading part of the computation to other elements of the system such as general purpose instruction-based processors and accelerators. Accelerator 911 may transfer the control to general purpose instruction-based processor 920 to complete the computation. In an alternative embodiment, accelerator 911 performs the computation completely and passes the output data elements to I/O interface 912. In another embodiment, accelerator 911 does not perform any computation on the input data elements and only passes the data to general purpose instruction-based processor 920 for computation. In another embodiment, general purpose instruction-based processor 920 may have accelerator 911 to take control and completes the computation before sending the output data elements to the I/O interface 912.

In an embodiment, accelerator 911 may be implemented using any device known to be used as accelerator, including but not limited to field-programmable gate array (FPGA), Coarse-Grained Reconfigurable Architecture (CGRA), general-purpose computing on graphics processing unit (GPGPU), many light-weight cores (MLWC), network general purpose instruction-based processor, I/O general purpose instruction-based processor, and application-specific integrated circuit (ASIC). In an embodiment, I/O interface 912 may provide connectivity to other interfaces that may be used in networks, storages, cameras, or other user interface devices. I/O interface 912 may include receive first in first out (FIFO) storage 913 and transmit FIFO storage 914. FIFO storages 913 and 914 may be implemented using SRAM, flip-flops, latches or any other suitable form of storage. The input packets are fed to the accelerator through receive FIFO storage 913 and the generated packets are sent over the network by the accelerator and/or general purpose instruction-based processor through transmit FIFO storage 914.

In an embodiment, I/O processing unit 910 may be Network Interface Card (NIC). In an embodiment of the invention, accelerator 911 is part of the NIC. In an embodiment, the NIC is on the same chip as general purpose instruction-based processor 920. In an alternative embodiment, the NIC 910 is on a separate chip coupled to general purpose instruction-based processor 920. In an embodiment, the NIC-based accelerator receives an incoming packet, as input data elements through I/O interface 912, processes the packet and generates the response packet(s) without involving general purpose instruction-based processor 920. Only when accelerator 911 cannot handle the input packet by itself, the packet is transferred to general purpose instruction-based processor 920. In an embodiment, accelerator 911 communicates with other I/O interfaces, for example, storage elements through direct memory access (DMA) to retrieve data without involving general purpose instruction-based processor 920.

Accelerator 911 and the general-purpose instruction-based processor 920 are coupled to shared memory 943 through private cache memories 941 and 942 respectively. In an embodiment, shared memory 943 is a coherent memory system. The coherent memory system may be implemented as shared cache. In an embodiment, the coherent memory system is implemented using multiples caches with coherency protocol in front of a higher capacity memory such as a DRAM.

In an embodiment, the transfer of data between different layers of accelerations may be done through dedicated channels directly between accelerator 911 and processor 920. In an embodiment, when the execution exits the last acceleration layer by accelerator 911, the control will be transferred to the general-purpose core 920.

Processing data by forming two paths of computations on accelerators and general purpose instruction-based processors (or multiple paths of computation when there are multiple acceleration layers) have many other applications apart from low-level network applications. For example, most emerging big-data applications in data centers have been moving toward scale-out architectures, a technology for scaling the processing power, memory capacity and bandwidth, as well as persistent storage capacity and bandwidth. These scale-out architectures are highly network-intensive. Therefore, they can benefit from acceleration. These applications, however, have a dynamic nature requiring frequent changes and modifications. Therefore, it is highly beneficial to automate the process of splitting an application into a fast-path that can be executed by an accelerator with subgraph templates and a slow-path that can be executed by a general-purpose instruction-based processor as disclosed herein.

While embodiments of the invention are shown as two accelerated and general-purpose layers throughout this document, it is appreciated by one skilled in the art that the invention can be implemented to include multiple layers of computation with different levels of acceleration and generality. For example, a FPGA accelerator can backed by a many-core hardware. In an embodiment, the many-core hardware can be backed by a general-purpose instruction-based processor.

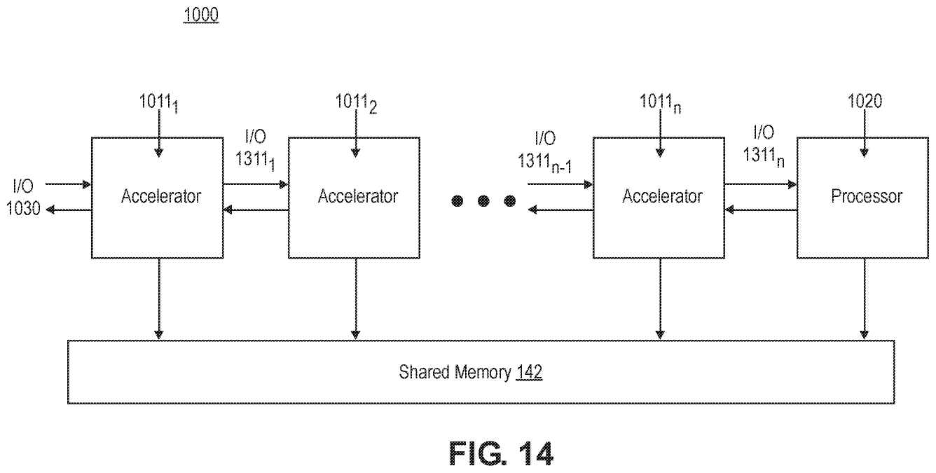

Referring to FIG. 14, in an embodiment of invention, a multi-layer system 1000 that utilizes a cache controller is formed by a first accelerator 1011₁ (e.g., in-line accelerator, offload accelerator for offloading processing from another computing resource, or both) and several other accelerators 1011ₙ (e.g., in-line accelerator, offload accelerator for offloading processing from another computing resource, or both). The multi-layer system 1000 includes several accelerators, each performing a particular level of acceleration. In such a system, execution may begin at a first layer by the first accelerator 1011₁. Then, each subsequent layer of acceleration is invoked when the execution exits the layer before it. For example, if the accelerator 1011₁ cannot finish the processing of the input data, the input data and the execution will be transferred to the next acceleration layer, accelerator 1011₂. In an embodiment, the transfer of data between different layers of accelerations may be done through dedicated channels between layers (e.g., 1311₁ to 1311₀. In an embodiment, when the execution exits the last acceleration layer by accelerator 1011ₙ, the control will be transferred to the general-purpose core 1020.

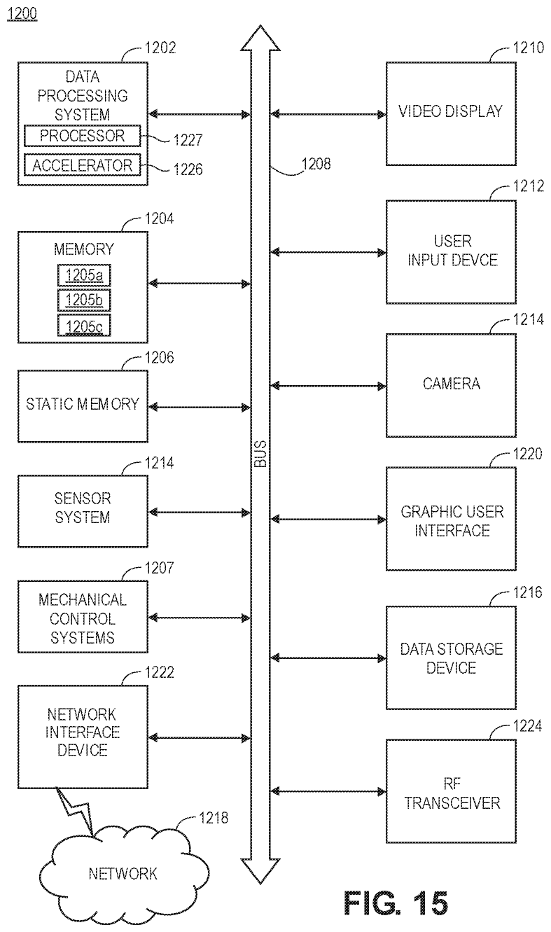

FIG. 15 is a diagram of a computer system including a data processing system that utilizes an accelerator with a cache controller according to an embodiment of the invention. Within the computer system 1200 is a set of instructions for causing the machine to perform any one or more of the methodologies discussed herein including accelerating operations of column-based database management systems. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes a general-purpose instruction-based processor 1227 and an accelerator 1226 (e.g., in-line accelerator, offload accelerator for offloading processing from another computing resource, or both). The general-purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein.

The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1200. Furthermore, memory 1206 may store additional modules and data structures not described above.

Operating system 1205a includes various procedures, sets of instructions, software components and/or drivers for controlling and managing general system tasks and facilitates communication between various hardware and software components. A compiler is a computer program (or set of programs) that transform source code written in a programming language into another computer language (e.g., target language, object code). A communication module 1205c provides communication with other devices utilizing the network interface device 1222 or RF transceiver 1224.

The computer system 1200 may further include a network interface device 1222. In an alternative embodiment, the data processing system disclose is integrated into the network interface device 1222 as disclosed herein. The computer system 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), a camera 1214, and a Graphic User Interface (GUI) device 1220 (e.g., a touch-screen with input & output functionality).

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The Data Storage Device 1216 may include a machine-readable storage medium (or more specifically a computer-readable storage medium) on which is stored one or more sets of instructions embodying any one or more of the methodologies or functions described herein.

Disclosed data storing mechanism may be implemented, completely or at least partially, within the main memory 1204 and/or within the data processing system 1202 by the computer system 1200, the main memory 1204 and the data processing system 1202 also constituting machine-readable storage media.

In one example, the computer system 1200 is an autonomous vehicle that may be connected (e.g., networked) to other machines or other autonomous vehicles in a LAN, WAN, or any network. The autonomous vehicle can be a distributed system that includes many computers networked within the vehicle. The autonomous vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The autonomous vehicle can operate in the capacity of a server or a client in a client-server network environment, or as a peer machine in a peer-to-peer (or distributed) network environment. The storage units

disclosed in computer system 1200 may be configured to implement data storing mechanisms for performing the operations of autonomous vehicles.

The computer system 1200 also includes sensor system 1214 and mechanical control systems 1207 (e.g., motors, driving wheel control, brake control, throttle control, etc.). The processing system 1202 executes software instructions to perform different features and functionality (e.g., driving decisions) and provide a graphical user interface 1220 for an occupant of the vehicle. The processing system 1202 performs the different features and functionality for autonomous operation of the vehicle based at least partially on receiving input from the sensor system 1214 that includes laser sensors, cameras, radar, GPS, and additional sensors. The processing system 1202 may be an electronic control unit for the vehicle.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A hardware accelerator for data stored in columnar storage format comprising:
memory to store data; and
a controller coupled to the memory, the controller to process at least a subset of a page of columnar format in an execution unit with any arbitrary scheduling across columns of the columnar storage format.

2. The hardware accelerator of claim 1, wherein the controller further comprises a page batching unit to process multiple pages in parallel while maximally utilizing the memory including a software-managed scratchpad and a hardware-managed cache.

3. The hardware accelerator of claim 1, wherein the controller further comprises a page walker to batch-pages together with a page-walker hardware routine that schedules processing of pages to the execution unit.

4. The hardware accelerator of claim 1, wherein the execution unit comprises:
a SIMD filtering hardware engine to process multiple operations per instruction to apply user-defined filtering conditions on incoming data; and
a configurable parser engine to read configuration or instructions that specify
a file size, compression algorithms used, filtering operation, and other metadata that is necessary for processing and filtering the format file.

5. The hardware accelerator of claim 4, wherein the execution unit further comprises:
a Decompress engine for decompression according to a compression algorithm used to compress data including repetition levels, definition levels, and values of a columnar storage format; and
a Page Splitter engine to split contents of a file into a page header, repetition levels, definition levels, and values to be individually processed by other engines.

6. The hardware accelerator of claim 5, wherein the execution unit further comprises:
a decoding engine to decompress or decode repetition levels, definition levels, and values, wherein based on the configuration accepted by the configurable parser engine, the decoding engine to perform decoding for one or more of RLE-BP, RLE, BP, Dictionary, Delta, and other algorithms supported for columnar formats.

7. The hardware accelerator of claim 1, wherein the controller comprises a scheduler that dynamically updates scheduling preferences in order to extract more parallelism or filtering reuse.

8. The hardware accelerator of claim 1, wherein the scheduler includes an internal profiler to monitor throughput to determine pages to prioritize for scheduling to maximize the reuse of filtering information stored in the memory.

9. The hardware accelerator of claim 1, wherein the profiler is capable of utilizing feedback to improve upon its scheduling algorithm from additional sources such as Reinforcement Learning, or history buffers and pattern matching.

10. The hardware accelerator of claim 1, wherein filtering effectiveness is reduced to improve parallelism for a plurality of execution units.

11. The hardware accelerator of claim 5, wherein the scheduler to schedule any arbitrary scheduling across columns with columns having at least one page and different page sizes available for each page.

12. A computer implemented method of operating a filtering engine of a hardware accelerator, the computer implemented method comprising:
accepting, with a controller, an incoming stream of data from a decoder and reading data from a memory of the hardware accelerator, wherein the memory tracks data filtered out by a previous column chunk; and
performing, with the filtering engine, value-based and metadata-based filtering of the data.

13. The computer-implemented method of claim 12, wherein the filtering engine performs SIMD-style execution to apply value-based and metadata-based filtering to the incoming stream of data.

14. The computer-implemented method of claim 13, further comprising:
discarding data based on the filtering of the filtering engine.

15. The computer-implemented method of claim 14, further comprising:
combining the filtered data and assembling the data to form an outgoing data stream.

16. The computer-implemented method of claim 15, further comprising:
updating the memory according to the filter applied for a current column chunk.

17. The computer-implemented method of claim 16, wherein the filtering engine tracks which bits have been filtered out for a column chunk and discards the corresponding entries for other column chunks and the filtering engine to support partial filtering of pages called sub-page filtering to best utilize available memory capacity.

18. The computer-implemented method of claim 16, wherein the filtering engine exposes the following parameters for effective scheduling:
total number of entries in a page, a number of entries to be filtered in the page, a range of entries valid in the memory, a range of entries that are valid in the memory for a previous column chunk, and offset address for the memory, wherein the filtering engine utilizes the memory and multiple SIMD (Single Instruction Multiple Data) lanes to store filtering results across columns, and produce filtered results as part of a larger pipeline to perform page level filtering.

19. A non-transitory machine-readable storage medium on which is stored one or more sets of instructions to implement a method of operating a filtering engine of a hardware accelerator, the method comprising:
accepting an incoming stream of data from a decoder; and
performing, with the filtering engine, in-place filtering of the data.

20. The computer-implemented method of claim 19, wherein the filtering engine performs SIMD-style execution to apply value-based and metadata-based filtering to the incoming stream of data.
